(19) United States
(12) Patent Application Publication
(10) Pub. No.: US 2008/0290167 A1
(43) Pub. Date: Nov. 27, 2008

(54) MULTI DIMENSIONAL READ HEAD ARRAY

(76) Inventor: Clay von Mueller, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/753,142

(22) Filed: May 24, 2007

(51) Int. Cl. G06K 7/08

(52) U.S. Cl. 235/449

(57) ABSTRACT

A method and apparatus for reading data from a track of a magnetic stripe are provided. According to one implementation, the method provides detecting a magnetic transition on the track by each of a plurality of read mechanisms arranged in a column across the track; determining an epoch for each detection of the transition by the plurality of read mechanisms; and characterizing the magnetic stripe based on the epochs determined for the transition detections. The apparatus can include a plurality of read mechanisms arranged so as to be oriented in a columnar array across the track when the track is moved relative to the array; and detection circuitry coupled to the read mechanisms.

### TECHNICAL FIELD

The present invention relates to token security, and more particularly, some embodiments relate to security for magnetic stripe tokens.

### DESCRIPTION OF THE RELATED ART

In many instances, it is desirable to provide a method and apparatus for storing and transporting information. In particular, many ways have been devised for encoding information on a medium that can be conveniently carried about by a person during the normal course of business. For example, credit cards, debit cards, electronic purse cards, decrementing value cards, driver's licenses, identification cards, access control cards, and many other such tokens that are small enough to be conveniently carried in a person's handbag or wallet are ubiquitous today. However, in many of the applications in which these media or tokens are intended to be used, security is an important concern. That is, it is important that only authorized organizations are capable of modifying the information stored thereon. One very common way for information to be stored on such a medium is by magnetically encoding the information. Techniques for encoding information on magnetic media have been available for many years and are now relatively inexpensive.

Magnetically encoded information can easily be copied or transferred from one magnetic information storage medium to another. Unless special provisions are made to secure the information, information can be altered and re-encoded back onto the original medium or a duplicate of the original medium. If the information is used in a system for organizing financial transactions or for personal identification, then such copying, altering, and duplicating makes the person for whom the information was intended, and the organization who operates the system, vulnerable to fraud. For example, if a magnetic stripe affixed to a debit card is used to indicate how much money is currently in a personal account, modifications to that information can be used to increase the apparent balance in order to purchase goods that have a higher value than actually exists in the account. Additionally, if the card is duplicated, the same account could be used by more than one person. It should be clear that fraud could occur in a number of ways if sensitive information is not properly secured. In fact fraud due to copying and modification of information magnetically encoded on portable media, such as magnetic stripe cards, is growing at an alarming rate.

A number of techniques have been proposed to authenticate both the information, and the medium on which the information is stored (commonly referred to as a “document” or a “token”), in order to prevent fraud. For example, U.S. Pat. No. 4,023,204 issued to Lee, discloses using a unique magnetic coating with pre-determined alignment of the magnetic particles as the basis for authentication measurements. Thus, a code that cannot be altered can be implanted into the document to authenticate the document. U.S. Pat. No. 5,336,871 issued to Colgate, discloses the use of a hologram to authenticate a substrate on which a magnetic stripe is affixed. U.S. Pat. No. 5,354,097, issued to Tel, discloses the use of overlays to authenticate information. U.S. Pat. No. 4,628,195, issued to Baus, discloses generating a security code number determined by the relative spatial positions of corresponding data in two different forms of encoded data on a card. In particular, Baus discloses using a conventional magnetic stripe as the first means for encoding data, and using embossed characters as a second means for encoding data. The relative position of the magnetic information with respect to the embossed information is used to generate a numeric security code. In addition, dyes or absorbers incorporated in a magnetic stripe have been used to attempt to encode a security identifier into the document on which the information resides.

However, each of these methods requires the use of special materials in the security process. Accordingly, none of the old documents would be usable, and all of the documents currently in use would have to be recalled and reissued using the new security process. Recalling and replacing all of the documents that are currently in use would be very costly and has hampered the widespread implementation of such technologies.

In the case of the technique disclosed by Baus, both an automatic reading method for reading the magnetic stripe, and also an automatic reading method for reading the embossed characters, are required. Therefore, there are two sub-systems required by this technique. Furthermore, readers used at the point-of-sale must preserve the spatial relationship between the magnetically stored information and the embossed characters. This is a cumbersome and expensive process that is very difficult to perform at the point-of-sale. Accordingly, it may be difficult to maintain reliable operation of systems that conform to the Baus technique.

Others have attempted to overcome the above limitations when the document is a magnetic medium by employing characteristics of the magnetic signals used to store the information to authenticate both the document and the information stored thereon. For example, U.S. Pat. No. 4,837,426 issued to Pease, discloses a method for authenticating documents by analyzing the amplitude of the magnetic signals. U.S. Pat. Nos. 5,408,505 and 5,428,683, each issued to Indeck, et al. disclose a method for authenticating documents using “noise” in the saturation region of the magnetic data. U.S. Pat. Nos. 5,235,166, and 5,430,279, each issued to Fernandez, and U.S. Pat. No. 5,254,843 issued to Hynes, each disclose a method of authenticating documents by deriving inherent temporal measurements of timing variations of the data in the reading process. All of the above-mentioned methods for authenticating documents and information using characteristics of the magnetic signals have a common drawback in that variations in the motion of the document through the reading device cause variations in the characteristics used to authenticate the document, and therefore result in errors in the authentication process. Furthermore, degradation of the reading device and the document over time due to natural wear causes the characteristics to either change, or to appear to change, causing further errors in the authentication process.

### BRIEF SUMMARY OF EMBODIMENTS OF THE INVENTION

According to various embodiments of the invention, aspects of magnetic tracks beyond the digital information they contain can be characterized and used to enhance security. In accordance with one particular embodiment of the invention pluralities of read heads for a single track are used to characterize aspects of the track for security purposes.

According to one embodiment of the invention, a column of read mechanisms is provided for a single magnetic track. The time intervals between detections of a logical transition by different heads in the column are used to characterize and distinguish the magnetic track.

According to another embodiment of the invention, a column of read mechanisms is provided for a single magnetic track. The order in which read mechanisms in the column detect a logical transition is used to characterize and distinguish the magnetic track.

According to another embodiment of the invention, a column of read mechanisms is provided for a single magnetic track. The time intervals between detections of a logical transition by different heads in the column and the order in which read mechanisms in the column detect the logical transition are used to characterize and distinguish the magnetic track.

According to another embodiment of the invention, a column of read mechanisms is provided for a single magnetic track. The number of non-logical transitions detected in a certain region is used to characterize and distinguish a magnetic track.

According to another embodiment of the invention, characterizations of logical transitions are compared as a means of authenticating a magnetic track.

According to another embodiment of the invention, two columns of read mechanisms are provided for a single magnetic track. Leading and trailing read mechanisms are used to calculate distance measurements between logical transitions that characterize and distinguish magnetic tracks.

According to another embodiment of the invention, a plurality of columns of read mechanisms is provided for a single magnetic track. The plurality of columns is used to take snapshots of the magnetic field properties of the magnetic track. The snapshots can be used to characterize and distinguish a magnetic track.

According to another embodiment of the invention, on or more columns of read heads are provided for a single magnetic track. The plurality of read mechanisms is used to measure remanent noise. The remanent noise can be used to characterize and distinguish a magnetic track.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is an illustration of an example transaction environment in which the present invention can be implemented.

FIG. 2 is an illustration of an additional example environment in which the present invention can be implemented.

FIG. 3 is an illustration of an example magnetic track used in conjunction with one embodiment of the present invention.

FIG. 4 is an illustration of an exemplary, non-uniform, logical transition on a magnetic track.

FIG. 5 is an illustration of a plurality of read heads arranged in accordance with one embodiment of the present invention.

FIG. 6 is a flow chart describing an exemplary method of operation in accordance with one embodiment of the present.

FIG. 7 is a flow chart describing another exemplary method of operation in accordance with one embodiment of the present.

FIG. 8 is a flow chart describing another exemplary method of operation in accordance with one embodiment of the present.

FIG. 9 is an illustration of an exemplary, non-uniform, edge region of a magnetic track.

FIG. 10 is a flow chart describing another exemplary method of operation in accordance with one embodiment of the present.

FIG. 11 is an illustration of a plurality of read heads arranged in accordance with one embodiment of the present invention.

FIG. 12 is an illustration of a plurality of read heads arranged in accordance with one embodiment of the present invention.

The figures are not intended to be exhaustive or to limit the invention to the precise form disclosed. It should be understood that the invention can be practiced with modification and alteration, and that the invention be limited only by the claims and the equivalents thereof. Note that the drawings include designations “N” and “S” to indicate the magnetic flux polarizations of areas of the magnetic medium. This should not be confused with the designations M and N used herein as variables to indicate a quantity of read mechanisms in an array.

### Detailed Description of the Embodiments of the Invention

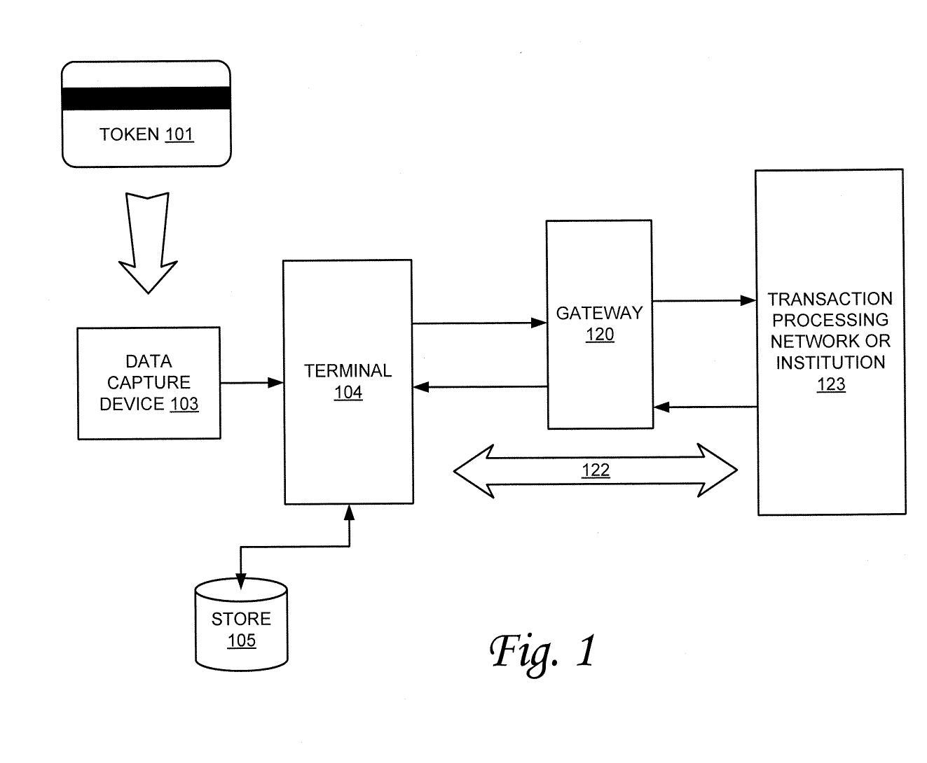

Before describing the invention in detail, it is useful to describe an example environment with which the invention can be implemented. One such example is that of a transaction card network including a token used to facilitate purchases or other transactions. FIG. 1 is a diagram illustrating one example of a transaction network with which the present invention can be implemented. Referring now to FIG. 1, an example of transaction network is a token network that can be used to authorize and settle purchases of various goods and services. Illustrative examples of implementations of such a transaction network are the charge card, credit card and debit card transaction networks used to facilitate purchase transactions and banking transactions by and among merchants and other businesses, banks and other financial institutions and individuals. Generally speaking, in such a transaction network, the customer utilizes a charge card, credit card, debit card or other token as a symbol of his or her identity, or as an identification of the account he or she would like to have charged for the transaction. The token is typically accepted by the merchant, the account information read, and used to credit the transaction. Merchants may ask for a driver's license or other form of identification to verify the identity of the purchaser in conjunction with the token issued.

The token data is then sent to the appropriate financial institution or institutions, or other entities for processing. Processing can include, in one or more steps, authorization, approval and settlement of the account. As the example in FIG. 1 illustrates, a token 101 can be used by the customer to facilitate the transaction. As stated, in this example environment, examples of token 101 can include a charge card, debit card, credit card, royalty card, or other token that can be used to identify such items as the customers, their account, and other relevant information. As a further example, a card such as a credit or debit card can include various forms of technology to store data, such as a magnetic stripe technology, to encode an account number or other identification or information onto the token. As such, a properly encoded token can include various forms of information relating to the purchaser such as, for example, the identity of the purchaser, information associated with the purchaser's account, the issuing bank or other financial institution, the expiration date, and so on.

As only one example of a token 101, a credit card can be used with a conventional magnetic stripe included on one side thereof. Conventional magnetic stripes can include three tracks of data. Further to this example, the ISO/IEC standard 7811, which is used by banks, specifies: that track one is 210 bits per inch (bpi), and holds 79 six-bit plus parity bit read-only characters; track two is 75 bpi, and holds 40 four-bit plus parity bit characters; and track three is 210 bpi, and holds 107 four-bit plus parity bit characters. Most conventional credit cards use tracks one and two for financial transactions. Track three is a read/write track (that includes an encrypted PIN, country code, currency units, amount authorized), but its usage is not standardized among banks.

In a conventional credit card token, the information on track one is contained in two formats. Format A, is reserved for proprietary use of the card issuer. Format B, which includes the following:
Start sentinel—1 character
Format code=“B”—1 character (alpha only)
Primary account number—up to 19 characters
Separator—1 character
Country code—3 characters
Name—2-26 characters
Separator—1 character
Expiration date or separator—4 characters or 1 character
Discretionary data—enough characters to fill out maximum record length (79 characters total)
End sentinel—1 character
Longitudinal Redundancy Check (LRC), a form of computed check character—1 character

The format for track two can be implemented as follows:
Start sentinel—1 character
Primary account number—up to 19 characters
Separator—1 character
Country code—3 characters
Expiration date or separator—4 characters or 1 character
Discretionary data—enough characters to fill out maximum record length (40 characters total)
LRC—1 character

Although a credit card with magnetic stripe data is only one example of a token that can be used in this and other environments, this example environment is often described herein in terms of a credit card implementation for clarity and for ease of discussion.

Upon entering into a transaction, a merchant may ask the customer to present his or her form of payment, which in this example is the credit card. The customer presents the token 101 (e.g., credit card) to the merchant for use in the transaction terminal 104. In one embodiment, the credit card can be swiped by a magnetic stripe reader or otherwise placed to be read by the data capture device 103. The data capture device is in communicative contact with a terminal 104, which can include any of a number of terminals including, for example, a point of sale terminal, point of access terminal, an authorization station, automated teller machine, computer terminal, personal computer, work stations, cell phone, PDA, handheld computing device and other data entry devices. Although in many applications the data capture device 103 is physically separated, but in communicative contact with, the terminal 104, in other environments these items can be in the same housing or in integrated housings. For example, terminals can those available from companies such as Ingenico, Verifone, Apriva, Linkpoint, Hypercom and others.

Continuing with the credit card example, the customer or cashier can swipe the customer's credit card using the card-swipe device, which reads the card data and forwards it to the cashier's cash register or other terminal 104. In one embodiment, the magnetic stripe reader or other data capture device 103 is physically separated, but in communicative contact with, the terminal 104. In other environments, these items can be in the same housing or in integrated housings. For example, in current implementations in retail centers, a magnetic stripe reader may be placed on a counter in proximity to a customer, and electronically coupled to the cash register terminal. The cash register terminal may also have a magnetic stripe reader for the sales clerk's use.

The customer may be asked to present a form of ID to verify his or her identity as imprinted on the token 101. For other transactions such as debit card transactions, the user may be required to key in a PIN or other authentication entry.

Continuing with the current credit card example, the terminal 104 can be configured to print out a receipt (or may display a signature page on a display screen) and the customer may be required to sign for his or her purchases, thus providing another level of authentication for the purchase. In some environments, terminal 104 can be configured to store a record of the transaction for recordkeeping and reporting purposes. Further, in some environments, a record of the transaction may be kept for later account settlement.

Typically, before the transaction is approved, terminal 104 seeks authorization from one or more entities in a transaction processing network 123. For example, the merchant may seek approval from the acquiring bank, the issuing bank, a clearing house, or other entity that may be used to approve such transactions. Thus, depending on the token type, institutions involved and other factors, the transaction processing network 123 can be a single entity or institution, or it can be a plurality of entities or institutions. As a further example, in one embodiment, transaction processing network may include one or more processors or clearing houses to clear transactions on behalf of issuing banks and acquiring banks. The transaction processing network also include those issuing banks and acquiring banks. For example, one or more entities such as Global Payments, Visa, American Express, and so on, might be a part of transaction processing network. Each of these entities may have one or more processing servers to handle transactions.

In some instances, the approval may also constitute the final settlement of the transaction resulting in the appropriate funds being transferred to consummate the transaction. In other embodiments, however, the authorization may simply be an authorization only and actual account settlement can take place in a subsequent transaction. For example, authorization may verify the validity of certain information such as the account number, expiration date, customer name, and credit limit to determine whether to approve the transaction. Settlement may be accomplished when a series of one or more approved transactions are sent to the appropriate institution(s) for transfer of the funds or other account settlement.

As illustrated in FIG. 1, a gateway 120 can be included to facilitate routing of transactions, authorizations and settlements to and from the appropriate entity or entities within the transaction processing network 123. For example, where a merchant accepts credit cards from numerous different institutions, the gateway can use the BIN (Bank Identification Number) obtained from token 101 and passed to gateway 120 to route the transaction to the institution(s) associated with the given BIN. As illustrated by flow arrow 122, not all transactions are necessarily routed through a gateway 120. Transactions may take other paths to the appropriate entity or entities in the transaction processing network 123. Additionally, the term gateway as used herein is not restricted to conventional gateway applications, but is broad enough to encompass any server or computing system configured to perform any or all of the described functionality. The term gateway is used for convenience only.

Although transaction processing network 123 is illustrated using only one block in the example block diagram environment of FIG. 1, this block can represent a single entity to which the transaction is routed for authorization or settlement, or a network of entities that may be involved with authorization and settlement. Communications among the various components in the example environment can be wired or wireless transmissions using a variety of communication technologies formats and protocols as may be deemed appropriate for the given environment. As one example, the currently available credit card processing network and protocol structure can be utilized as the environment with which embodiments of the invention can be implemented. In fact, in one embodiment of the invention, various features and functions of the invention can be implemented within current or legacy transaction processing networks to provide enhanced features while reducing the level of change or upgrade required to the networking infrastructure.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

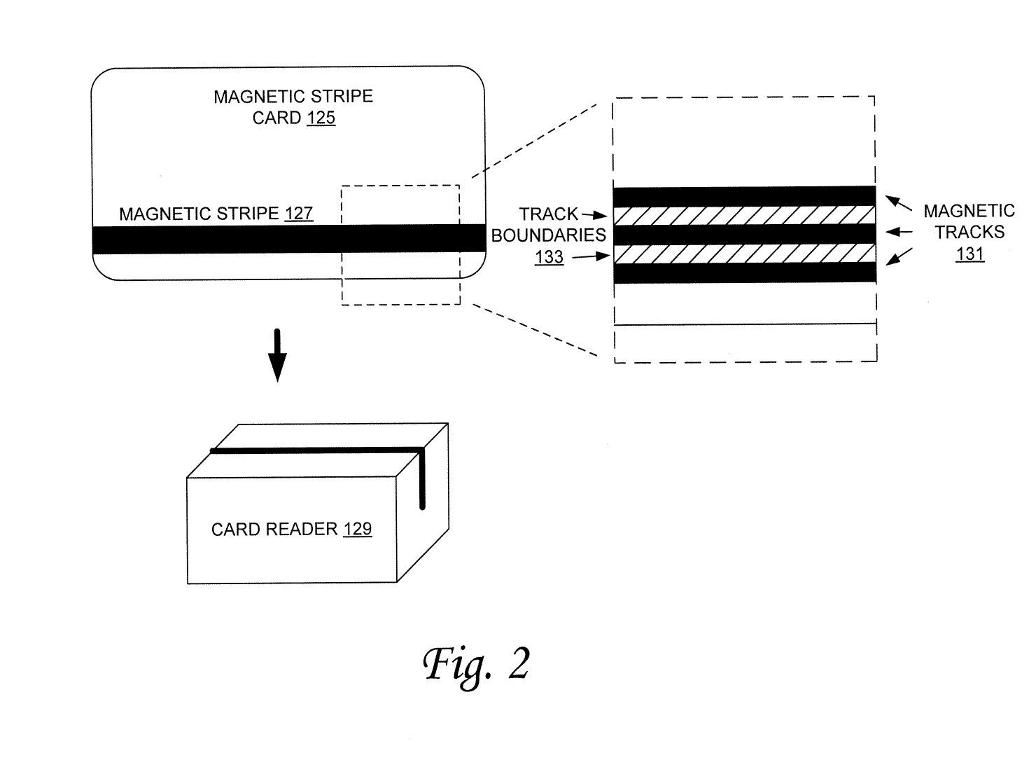

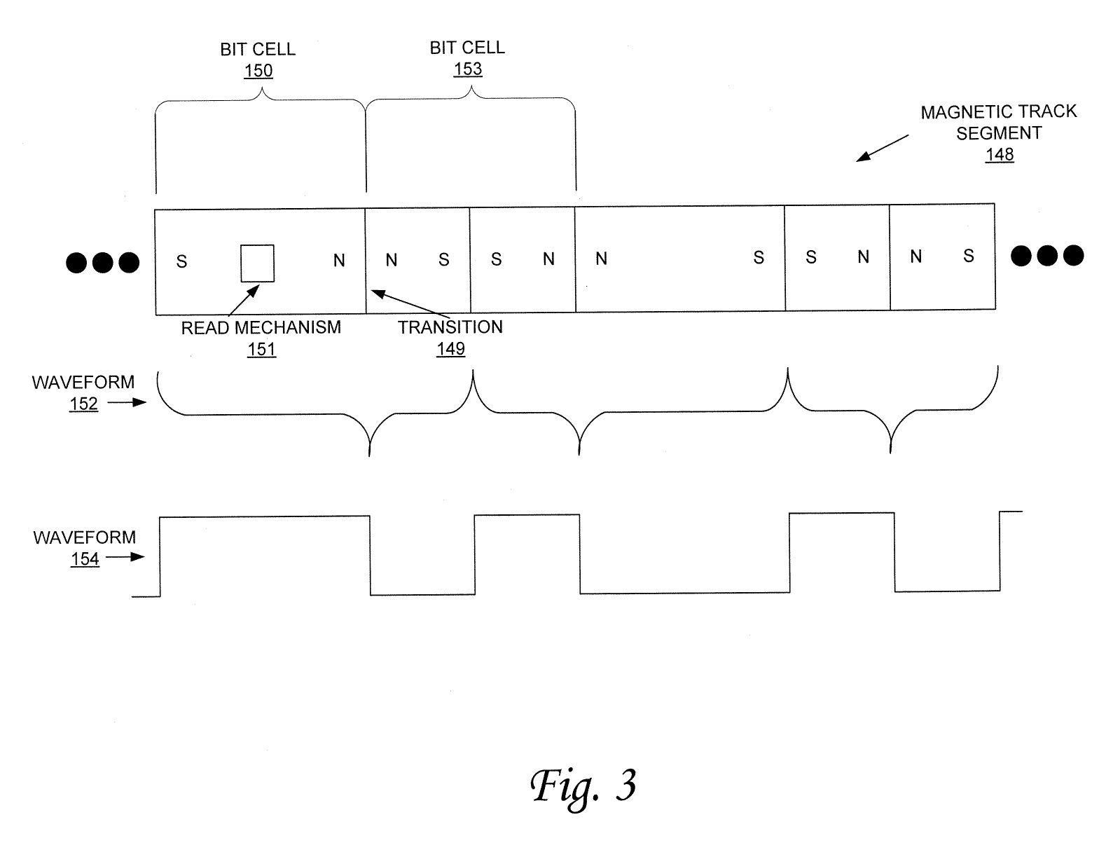

FIGS. 2 and 3 describe aspects of magnetic stripe technology that, while known in the art, may be useful in understanding the present invention. Specifically, FIG. 2 uses another sample environment to further describe aspects of magnetic stripe technology related to magnetic tracks. This example environment features magnetic stripe card 125. Magnetic stripe card 125 may be, for example, a credit card, debit card, charge card, ID card, loyalty card, security card, or other card using a magnetic stripe 127 to hold data. In general, magnetic stripe card 125 represents any token or document that uses a magnetic stripe 127 to store data. Card reader 129 represents any device capable of extracting data from magnetic stripe 127.

In one embodiment, the present invention relates to systems and methods employed by card reader 129 to extract information from magnetic stripe 127. In another embodiment, the present invention relates to systems and methods for security and authentication in transactions involving the use of media that utilize magnetic stripe technology. For the purpose of illustration and clarification, an enlarged depiction of a portion of magnetic stripe 127 is shown. As described above, a magnetic stripe may have one or more discrete tracks upon which information is encoded. For purposes of explanation only, this exemplary environment depicts a magnetic stripe having three separate tracks 131. As described in relation to FIG. 1, a magnetic stripe with three tracks has been adopted as a standard for many financial institutions. The type of data, the format of the data, the amount of data, the density of data, and other factors may vary widely between tokens and between tracks on a given token or token type. Further, the number of tracks used may vary by application.

Track boundaries 133 between tracks 131 are illustrated in the present sample environment. Track boundaries 133 are illustrated as defined spaces between tracks 131 solely for the purpose of explanation. In reality, track boundaries 133 may be conceptual boundaries between recognized tracks 131. Alternatively, tracks may be separated by a defined amount of space, by discontinuity in material properties, or by regions of magnetic material that are unreliably written to and read from in standard use. Where a reader 129 is configured to read data from multiple tracks, the reader may include multiple read heads or read gaps to read data from the multiple tracks.

FIG. 3 is an illustration of a region of a magnetic track. For the purpose of explanation, sample track region 148 is illustrated as being divided into a series of magnetic dipoles. In reality, each dipole might comprise a vast number of magnetic particles that have been aligned in a particular direction. It will be appreciated that the depiction of dipoles as uniform regions is an oversimplification made for the purpose of explanation. The boundary between two dipoles may be referred to as a transition. Example transition 149 is illustrated between two dipoles. It will be appreciated that the term logical transition is used to indicate an intentionally formed boundary between two dipoles. For example, a logical transition may be formed to indicate a certain data value, to convey clocking information, or for other purposes. Non-logical transitions may be thought of as transitions created unintentionally due to, for example, imprecision in writing to the magnetic track or variance in material properties. In general, both logical and non-logical transitions may be thought of as regions where sufficiently dissimilarly aligned magnetic regions abut.

The boundary between inconsistently aligned magnetic regions generates a magnetic field that can be identified by read mechanisms such as exemplary read mechanism 151. It will be appreciated that many types of read mechanisms might exist to detect variation in magnetic fields. For example, some devices that read magnetic stripe media use read heads that measure current induced by the change in magnetic field. Other read heads measure the change in resistance caused by a change in magnetic field properties. It will be appreciated that the present invention may be practiced independent of the type of read structure used. As such, references to read structures, read mechanisms, read heads, read gaps, or other similar terms should be taken to refer to entities capable of extracting information based on the magnetic field properties. Similarly, references to a plurality of read devices, read heads, read mechanisms, read gaps, or other such references should be understood to refer to a plurality of entities capable of extracting information from a magnetic field. The plurality of read mechanisms need not be formed as part of a single apparatus or comprise a plurality of separate apparatuses.

For the purposes of explanation, one possible configuration of the functionality of exemplary read mechanism 151 may be considered in more detail. As the track segment 148 and read mechanism 151 move relative to each other, exemplary read head 151 is able to detect variations in the magnetic field. During the read process, read mechanism 151 may generate a waveform representative of the extracted magnetic field. For example, the waveform might appear similar to the illustrated waveform 152. The peaks and troughs of waveform 152 correspond to certain changes in magnetic field properties that approximately coincide with the position of logical transitions on track 148. In some applications, a peak detector (not illustrated) might be used to process the generated waveform 152. The use of peak detectors to digitize analog signals is well known in the art. The output of the peak detector might look something like illustrated waveform 154. In some applications, a particular decoding scheme may then be applied to extract binary data from waveform 154.

In one context, track 148 may also be thought of as comprising a series of bit cells. A bit cell may be thought of as a defined amount of space on a magnetic track. For example, as described above the ISO/IEC standard 7811, which is used by banks, specifies, in certain circumstances, that data be written with 210 bits per inch (bpi). Generally, the start and end of a bit cell coincide with logical transitions. In certain encoding schemes, a single bit cell may comprise one or more intentionally formed dipoles. For example, bit cell 150 and bit cell 153 each comprise the same fixed amount of space. Each bit cell begins and ends on a logical transition. However, bit cell 150 has no intermediate logical transitions while bit cell 153 has one intermediate transition. Alternatively, bit cell 150 comprises a single dipole while bit cell 153 comprises two dipoles. In one example, a single digital bit is associated with each bit cell on a track. According to one example, the absence of an intermediate logical transition in a bit cell may be interpreted as the bit cell representing a logical 0. Similarly, the presence of an intermediate logical transition in a bit cell may be interpreted as the bit cell representing a logical 1. Accordingly, in that example, bit cell 150 would be interpreted as a representing a 0 while bit cell 153 would be interpreted as representing a 1. The encoding scheme and organization described in relation to FIG. 3 are provided solely for the purpose for explanation and should not be understood to constrain the types of magnetic stripe technology to which embodiments of the present invention may be applied.

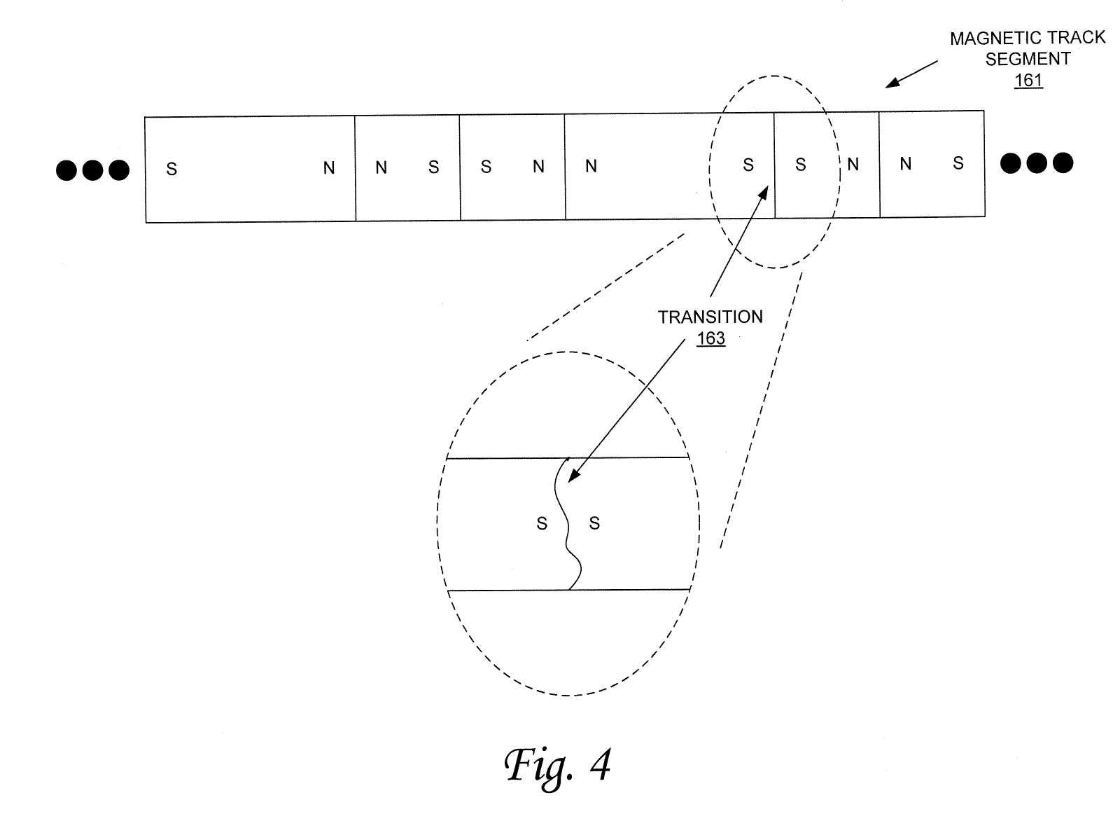

Having explained a general environment in which the present invention may be applied, it may be useful for the purpose of explanation to consider a more specific environment for the application of the present invention. FIG. 4 is another representation of an exemplary portion of a magnetic track 161. In particular, transition 163 is depicted. The example transition 163 is a logical transition between two diploes. The representation of transition 163 as uniform is an oversimplification. To aid in explanation, a more detailed representation of transition 163 is provided. In reality, and as depicted in greater detail, transition 163 is likely to be non-uniform. Many factors may contribute to this non-uniformity. For example, during the writing process, variance in magnetic field emitted by the writing mechanism may cause non-uniform alignment of magnetic particles. Alternatively, even in the presence of uniform magnetic field strength, the orientation of the track and the speed at which it passes by the writing mechanism may lead to non-uniformity. Alternatively, variance in the density of magnetic particles throughout the track might lead to non-uniformity. Regardless of the source, non-uniformity of transition 163 is probable. In one embodiment, the present invention relates to systems and methods for utilizing the non-uniformity of logical transitions. In accordance with the present invention, the non-uniformity of transitions may be used to distinguish between two tracks containing identical digital data. Alternatively, the non-uniformity of transitions may be used to enhance security in other ways that will be described in greater detail herein.

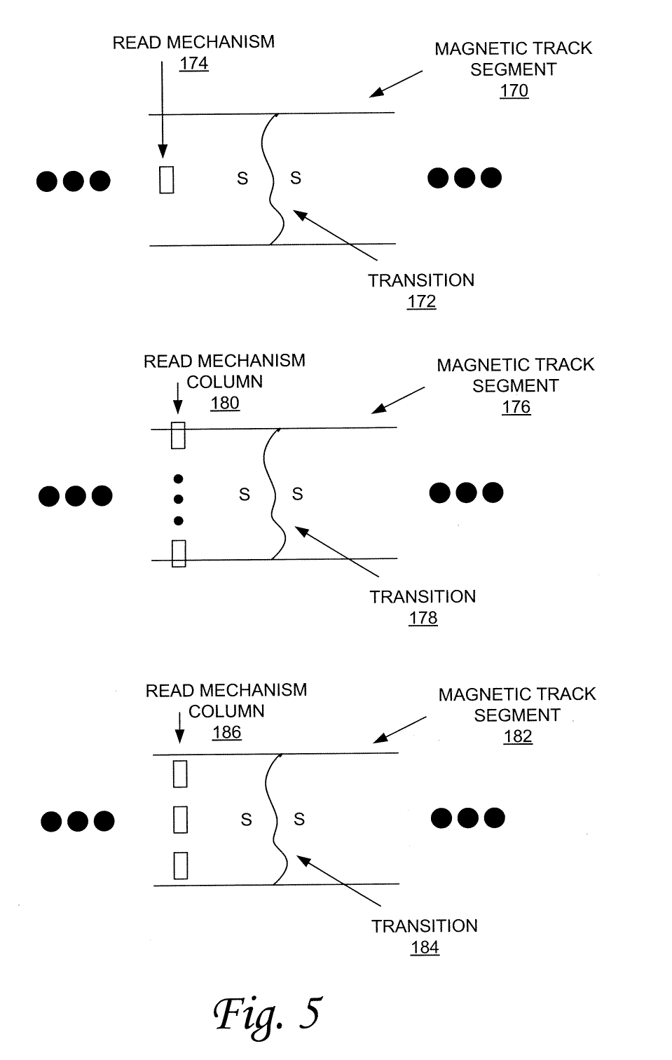

In accordance with one embodiment of the present invention, in order to use non-uniformity of transitions to enhance security, the non-uniformity might be measured, quantified, interpreted, or assessed in some respect. FIG. 5 depicts both the traditional approach to dealing with non-uniform logical transitions and an approach to measuring the non-uniformity of logical transitions consistent with one embodiment of the present invention. Referring now to FIG. 5, a magnetic track section 170 is illustrated with a non-uniform logical transition 172. Traditionally, a single read mechanism 174 is used to read data from track 170. Further, the single read mechanism 174 is traditionally placed at the center of the track 170 to minimize the detection of magnetic field variation caused by non-uniformity more prevalent in the edge areas of the track 170.

Minimizing the detection of non-uniformity in traditional approaches may enhance the reliability of the traditional read process, but it can also cut off access to additional information, which may be used to enhance the security of transactions. For example, as described above, the exact nature of non-uniformity of logical transitions might be a combination of many factors, some of which might be complex. As such, a particular pattern of non-uniformity may both approach uniqueness and might be difficult to replicate. Instead of minimizing the detection of the non-uniformity, the present invention, in one embodiment, provides systems and methods for determining the non-uniformity of logical transitions and utilizing it to secure transactions.

FIG. 5 also illustrates magnetic track segment 176 with non-uniform logical transition 178. In accordance with one embodiment of the present invention, a plurality of read mechanisms 180 is provided for track segment 176. In one embodiment, the plurality of read mechanisms is arranged as a column. It will be appreciated that term column is used to express an alignment exactly, substantially, approximately or roughly perpendicular to the longitudinal dimension of the magnetic track. Such a column can also be described as oriented across the track, as opposed to along the track, regardless of whether the array extends partially or completely across the width of the track, or whether or not it extends beyond the width of the track. Although the illustrated example array is a column of 1×N read mechanisms 180, in other embodiments another array of read mechanisms 180 in an alternative orientation might be utilized. Further, it will be appreciated that one or more of the read mechanisms 180 may extend beyond the boundary of track 176.

Any read mechanism extending within the boundaries of track 176 or that is significantly affected by the magnetic field of track 176 may be considered a constituent of the plurality of read mechanisms 180. In a specific embodiment of the present invention, a column of three read mechanisms 186 is provided for track 182. This column of three read mechanisms 186, is used to derive information about the non-uniformity of transition 184 in accordance with one embodiment of the present invention. It will be appreciated that in this embodiment, a single read mechanism is provided approximately at the center of the track 182 while the other two read mechanisms are provided nearer to the edges of track 182. Advantageously, this example embodiment provides a read mechanism in the same position as is provided in the traditional approach, but also provides additional read mechanisms that can be used to gather information about the non-uniformity logical transition 184. Methods, in accordance with embodiments of the present invention, for using the plurality of read mechanisms to gather and use information about the non-uniformity of transitions are discussed in greater detail below.

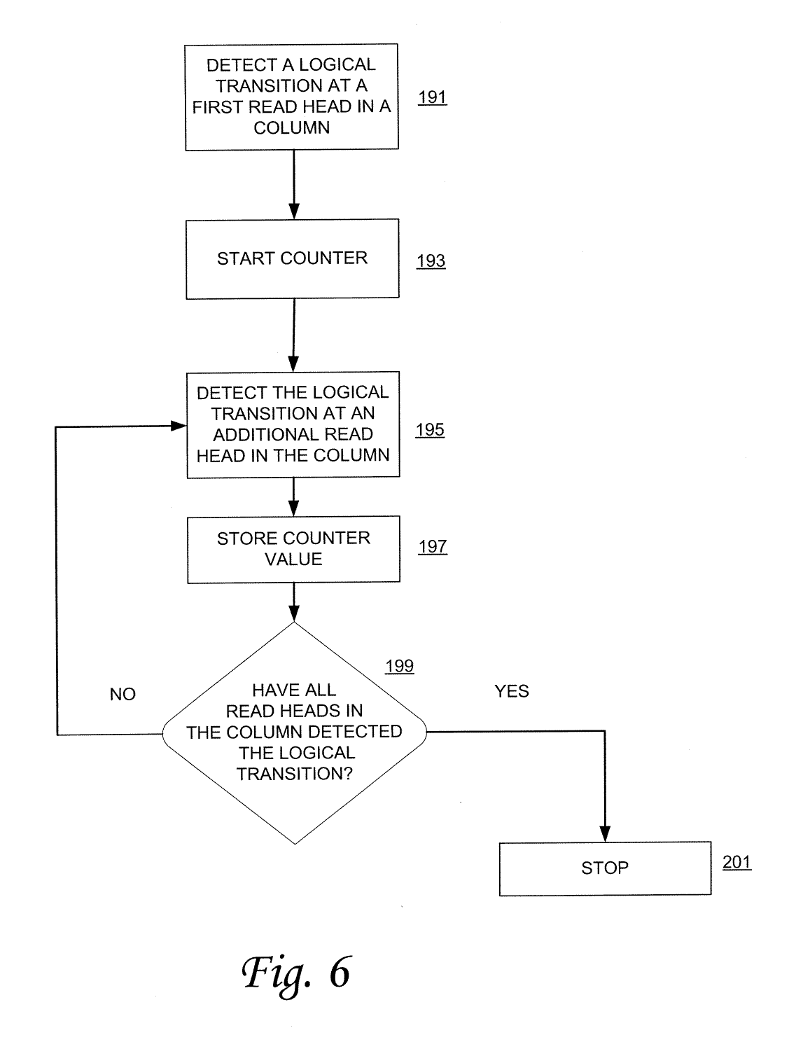

Having described an exemplary structure of read mechanisms for gathering information about the non-uniformity of transitions on a magnetic track, it may be useful to consider an exemplary use of the read structure in accordance with one embodiment of the present invention. FIG. 6 describes an exemplary method of using the read structure described in relation to FIG. 5 in accordance with one embodiment of the present invention. The method uses a plurality of read mechanisms on a given magnetic track to characterize the non-uniformity of a logical transition. Once the transitions on a medium are characterized, subsequent readings of the medium (or a medium purported to be the same medium) might be compared to the characterized values to determine the authenticity or veracity of the subsequently presented medium.

Referring now to FIG. 6, in a step 191, a read mechanism in the column detects the logical transition. Responsive to the detection of the transition by a first head in the column, an epoch representing the detection by that read mechanism is generated. In one embodiment, the epoch can denote time of detection. Thus, in one embodiment a counter or timing mechanism is started as shown in step 193. As will be appreciated, the rate at which the counter increments, or the counter resolution, can be used to affect the degree of accuracy to which the non-logical transition may be characterized. However, the invention might be implemented such that the frequency of the counter may be increased or decreased to satisfy the requirements of a particular situation. After starting the counter, time elapses until an additional read mechanism in the column detects the logical transition, as shown in step 195. The counter value at approximately the time the additional read mechanism detects the transition is stored as shown in step 197. After the counter value is stored, a determination is made as to whether all the read mechanisms in the column have detected the logical transition, as shown in step 199. If not, the method loops back and waits for an additional read mechanism to detect the logical transition. When each additional read mechanism detects the logical transition, the counter or timer value for the additional read mechanism is stored. After all the read mechanisms in the column have detected the logical transition, the method ends as shown in step 201.

For the purpose of explanation, it may be useful to consider an exemplary execution of the present method. For example, consider a column of three read mechanisms positioned to detect a logical transition on a magnetic track (perhaps, for example, similar to column 186 in FIG. 5). It will be appreciated that in relation to the present example, numerical terms used to refer to different read mechanisms in the column do not necessarily convey relative positional information. Numerical references convey the order in which the read heads detect the transition. As the track passes the read mechanisms, a first read mechanism detects a particular logical transition. Responsive to this detection, a counter is started. It will be appreciated that the approximate bounds for the placement of logical transitions may be known. As such, in an alternative embodiment of the method, the counter may start before a first read mechanism in the column detects the transition. The counter could be configured to start at the time when the outer most bound of where the transition is likely to extend is approaching the column of read mechanisms. In another embodiment, the counter value at the time a first read mechanism in the column detects the transition may be stored as well. Continuing in the present example, when the second read mechanism in the column detects the logical transition, the current counter value is stored. For the purposes of the present explanation, it will be assumed that the counter value at the time the second read mechanism detects the logical transition is <25>. Eventually, the third read mechanism in the column detects the transition as well. For the purposes of the present explanation, it will be assumed that the counter value at the time the third read mechanism detects the logical transition is <100>. Since all the read mechanisms have detected the logical transition the execution of the method ends for this transition. In an alternative embodiment, the execution may end without each read mechanism having detected the logical transition. For example, if the counter value reaches a certain value before all the read mechanisms have detected the transition, it might be assumed that the balance of the read mechanisms will never detect the logical transition. At the end of the execution of the method, counter values <25> and <100> have been stored. For the purpose of explanation, the stored values may be thought of as a set <25, 100> of counter values that characterize the non-uniformity of the transition.

Without modification, the stored counter values characterizing a particular transition may change based on the speed at which the track passes the read mechanisms. For example, if the track were moving half as fast, the stored counter values for the example transition would be <50> and <200> respectively. In one embodiment of the present invention, the stored counter values may be modified to account for the speed at which the track passes the read mechanisms. For example, the stored counter values may be divided by the highest counter value stored. The counter value set of the present example, <25, 100>, would become <0.25, 1>. The counter value set of the present example at half speed, <50, 200>, would become <0.25, 1> as well. It will be appreciated that other means of compensating for speed may be used as well. It will also be appreciated that the use of more read mechanisms will result in larger counter value sets which characterize the non-uniformity of transitions in greater detail.

In accordance with one embodiment of the present invention, the stored counter values may be used to enhance the security of transactions utilizing magnetic stripe technology. For example, consider the situation in which a thief may try to copy the contents of a magnetic track onto a duplicate track. This is sometimes referred to as skimming. In one embodiment, the present invention might be used to generate a set of counter value sets describing one or more transitions on the original magnetic track. Representations of these counter value sets may be stored on the track itself or elsewhere. While the thief may succeed in copying the digital information on the original track onto a duplicate track, the non-uniformity of the transitions on the duplicate track would typically be different from those of the original track. In accordance with one embodiment of the present invention, if the set of counter values sets characterizing transitions of the duplicate track is generated, this set can be compared to the set of counter value sets characterizing corresponding tracks on the original track. If the sets do not match (for example, due to the various factors described above), the attempted fraud will become apparent and the use of the duplicate can be denied. In effect, a set of counter values characterizing transitions on a track may be, or may be a part of, an authentication signature or a fingerprint for the magnetic track. In one embodiment, exact matches of all sets might be required to authenticate a medium. In other embodiments, thresholds or other techniques might be used to account for variations in the process from one read operation to the next. Thus, the invention might be implemented to look for a ‘match’ of counter values sets for a predetermined quantity of transitions and similarly might be implemented to find a match exists in counter values sets where the ratios are the same or where the comparison is within a certain percentage of the original.

In another embodiment of the present invention, the non-uniformity of transitions may be used in other security applications. For example, as described above, many complex factors contribute to the non-uniformity of transitions. The overall complexity causes the resulting non-uniformity to approach randomness for practical considerations. As such, epochs characterizing the non-uniformity of transitions display properties of this randomness. In one embodiment, the epochs might represent sets of counter values. Sets of counter values characterizing transitions might be manipulated according to mathematic principles to form random numbers. In an alternative embodiment, sets of counter values may be manipulated according to mathematic principles to form the seed for a random number generator. In an alternative embodiment, sets of counter values describing the non-uniformity of transitions on a magnetic track may be used in any application requiring random-like inputs. In another embodiment, sets of counter values may be used to evaluate the properties of writing mechanisms.

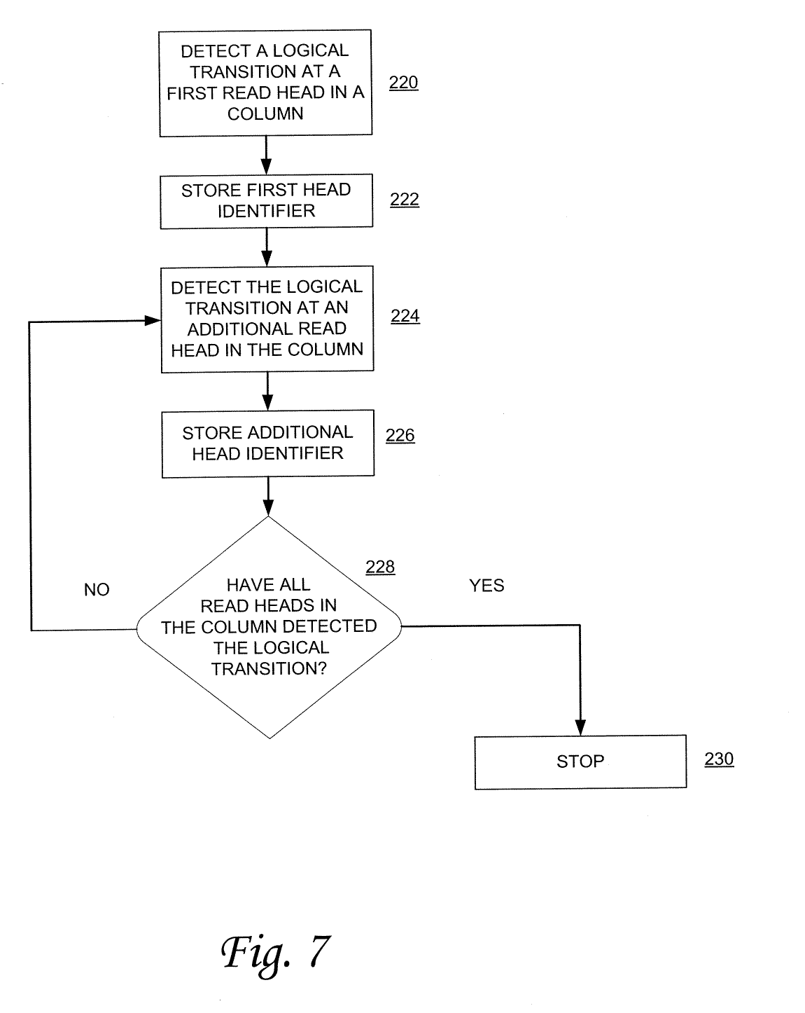

In another embodiment, the present invention provides for characterizing transitions in ways other than using time measurements. Specifically, FIG. 7 describes another method of utilizing the read mechanisms described in relation to FIG. 5 in accordance with the present invention. As before, the method begins when a first read mechanism in the column detects a particular transition as shown in step 220. Responsive to the detection, an epoch can be generated. In this example embodiment, the epoch refers to the order in which the read mechanisms detected the transition. Thus, in one implementation, an identifier associated with the first read head is stored as shown in step 222. Subsequently, an additional read head in the column detects the logical transition as shown in step 224. Upon detection, an identifier associated with the additional read head is stored as shown in step 226. A decision is then made as to whether all the read heads in the column have detected the logical transition as shown in step 228. If not, the process of additional read mechanisms detecting the transition and storing their identifiers might continue. Once all the read mechanisms in the column have detected the transition and their identifiers have been stored, the process stops as shown in step 230. In an alternative embodiment, the process may stop after a certain amount of time or a certain number of read mechanisms regardless of whether all the read mechanisms in the column have detected the particular transition.

As above, it may be useful for the purposes of explanation to consider the operation of the method described in relation to FIG. 7. In one example, three read mechanisms arranged as a column are provided for reading data from a magnetic track. An identifier is associated with each read mechanism for purposes of discussion only. For the present example, letter identifiers <A>, <B>, and <C> will be associated with the read mechanisms. For the purpose of the present example, it will be assumed that as the track passes the read mechanisms, read mechanism <C> is the first to detect the logical transition, read mechanism <A> is the second, and read mechanism <B> is the third. Expressed collectively, the stored read mechanisms indicators might be thought of in one embodiment as an ordered set <C, A, B>. It will be appreciated that the order of the stored mechanism indicators provides another means of characterizing the non-uniformity of the transition. The order of the stored read mechanisms can be used to differentiate the transition of the present example from other transitions. For example, a transition characterized by an ordered set <C, A, B> can be easily differentiated from a transition characterized by an ordered set <B, C, A>. As with the method of characterizing the non-uniformity of transitions described in relation to FIG. 6, the stored outputs can be used to enhance the security of transactions using magnetic stripe technology and to generate random-like outputs.

For example, where an original medium is read and the transition detected, the medium can be characterized by the plurality of ordered sets generated for the transitions. As another medium is presented purporting to be the same medium, the ordered sets for the presented medium can be generated and compared to the original to determine authenticity. Thus, a direct comparison of the data sets can be used. In other embodiments, the ordered sets may be manipulated according to mathematic principles to generate, amongst other things, random numbers, seeds for random number generators and authentication signatures. Alternatively, the ordered sets may be used to evaluate the performance of writing mechanisms. Advantageously, the present method of characterizing non-uniformity in transitions might be implemented to work without having to compensate for the speed at which the track and the read mechanisms pass each other. Further, the stored ordered sets can be used to enhance the security of magnetic stripe transactions.

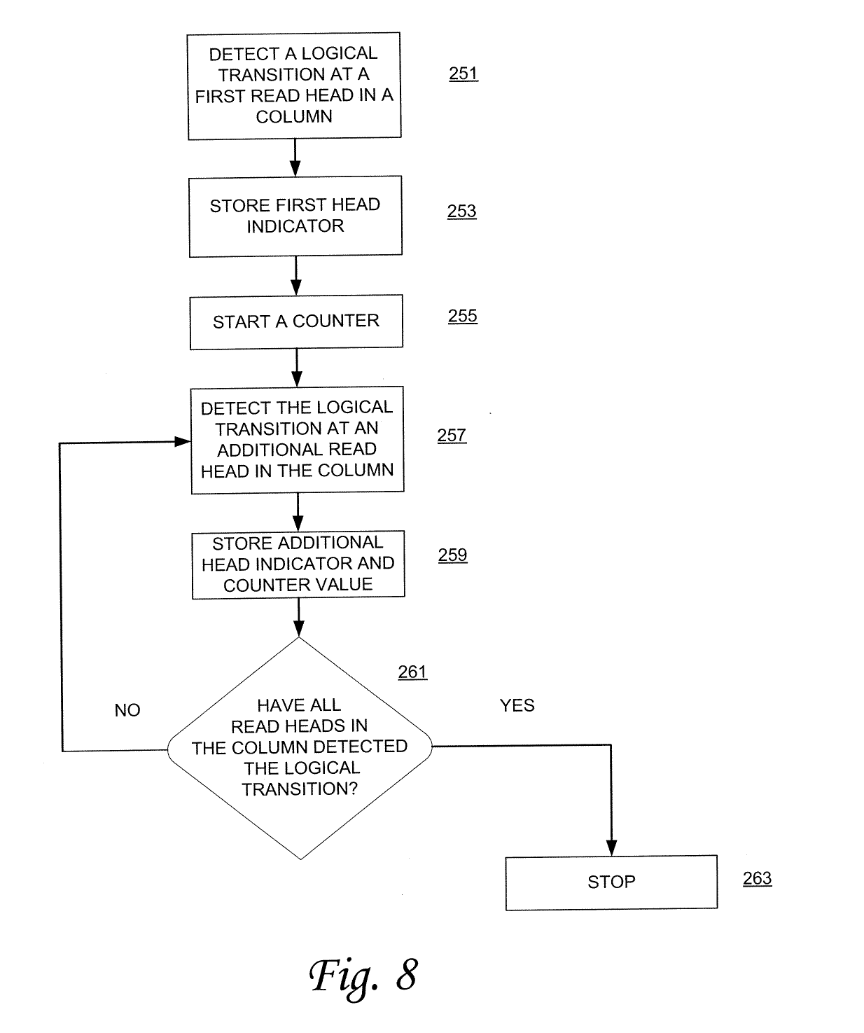

In addition to using time and order measurements independently, in one embodiment of the present invention, both time and order characterizations of non-uniformity of transitions can be used to enhance the security transactions involving the use of magnetic stripe technology. Specifically, FIG. 8 describes another method of utilizing the read mechanisms described in relationship to FIG. 5 to characterize non-uniformity of transitions in accordance with the present invention. The method begins when a first read mechanism in the column detects the transition as shown in step 251. Responsive to this detection, an indicator associated with the first read mechanism is stored as shown in step 253 and a counter is started as shown in step 255. In another embodiment of the invention, the counter may be started before the detection of the transition by the first read mechanism. For example, the counter may be started at a time just before the read mechanisms pass by a region of the track where a transition is expected to be. The counter value at the time the first read head detects the transition may be stored as well. After the counter is started, time elapses until a subsequent read mechanism detects the transition as shown in step 257. Both an indicator associated with the read mechanism and the counter value are stored at the time of detection as shown in FIG. 259. As before, a decision is then made as to whether all the read mechanisms in the column have detected the transition as shown in step 261. If not, time elapses and the process of detection and storing of a read mechanism indicator and counter value repeats. Once all the read mechanisms have detected the transition, the method ends as shown in step 263. Alternatively, the method may end before all the read mechanisms in the column have detected the column. For example, the method may end a certain amount of time after the detection of the transition by a first read mechanism in the column. The values stored during the operation of the present method may be used to characterize the non-uniformity of a transition in the same ways as described in relationship to the methods described in FIGS. 6 and 7. However, because both order of detection and relative time intervals of detection may be stored in conjunction, the characterization provided by the present method is more descriptive than the characterization provided by the previously described methods. For example, each pair consisting of a counter value and a read mechanism identifier may be thought of as a coordinate. The set of coordinates describing one transition could be compared to the set of coordinates describing another transition using optical or pattern recognition algorithms. It will be appreciated that other means of comparing data could also be used. Advantageously, and amongst other things, the present method for providing a detailed characterization of the non-uniformity of a transition enables sophisticated authentication of media using magnetic tracks.

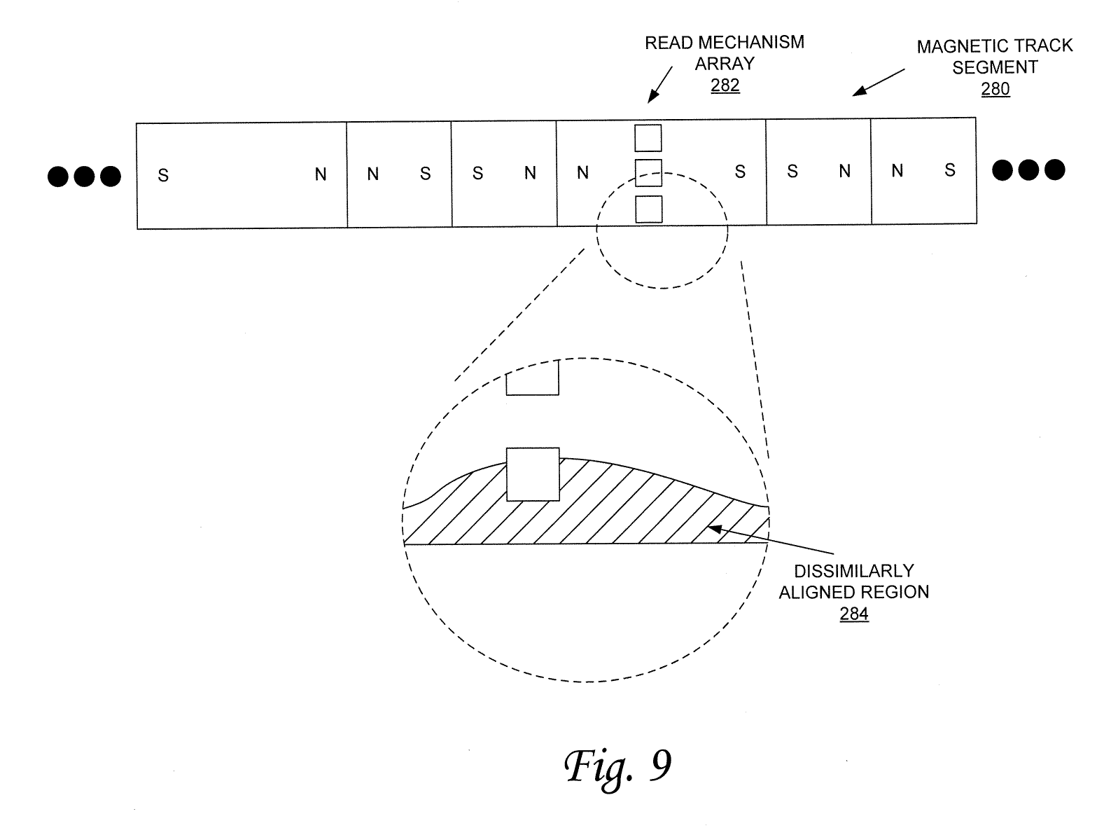

In addition to non-uniformity of transitions, magnetic tracks have other non-uniformities that may be used to enhance security. For example, FIG. 9 illustrates another type of non-uniformity that can be used to enhance security in accordance with one embodiment of the invention. A segment of magnetic track 280 is illustrated. Traditionally, write devices do not emit a magnetic field that effectively and uniformly aligns particles all the way to the edges of track 280. This may be done intentionally, for example, to avoid interfering with adjoining tracks. Alternatively, it may result unintentionally from variance in the field generated by the write device or due to the difficulty of generating a uniform field in the appropriate region. Regardless of the source, edge regions of a track may contain pockets or areas of dissimilarly aligned magnetic particles. In an enlarged view, an example of how a dissimilarly aligned region 284 might appear is illustrated. Again, for the purposes of explanation, the borders between dissimilarly aligned magnetic areas are referred to as transitions. While some previous embodiments of the present invention dealt with characterizing non-uniformity of at least intentionally placed transitions, another embodiment of the present invention deals with characterizing unintentionally formed transitions such as often occur in edge regions of the track. Traditionally, a single read mechanism is placed at the center of the track to avoid detection of dissimilarly aligned region 284. However, in accordance with one embodiment of the present invention, a plurality of read mechanisms 282 is supplied for track 280. The plurality of read mechanisms 282 is arranged as a column or other array to facilitate detection and characterizations of dissimilarly aligned edge regions 284. As with the non-uniformity displayed in logical transitions, the non-uniformity of these edge regions might be a product of many factors, some of which are complex. As such, characterizations of the non-uniformity may be used to enhance the security of magnetic stripe media in ways similar to those described already herein.

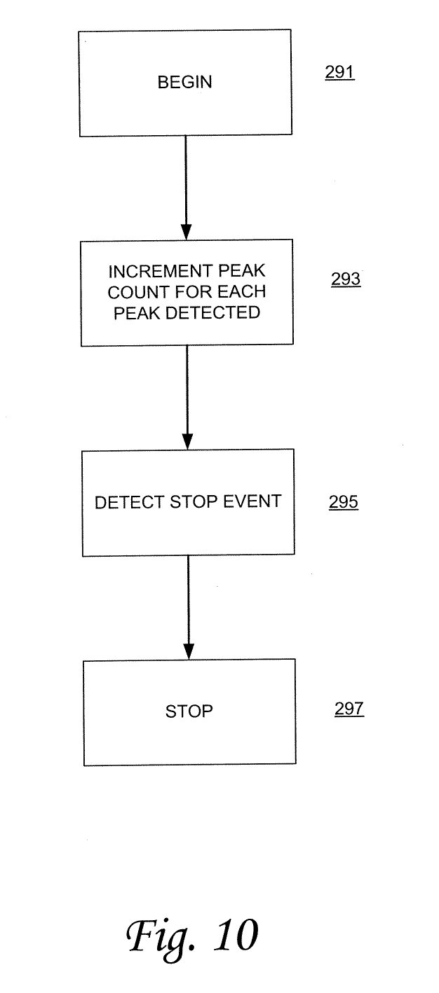

Having described another source of non-uniformity for characterization of a magnetic track, it may be useful to consider an exemplary method in accordance with an embodiment of the present invention for characterizing this non-uniformity. FIG. 10 describes a method of characterizing non-uniformity in edge regions of a magnetic track in accordance with one embodiment of the present invention. The execution of the method begins when a start condition is detected as shown in step 291. This start condition may be, amongst other things, the detection of a logical transition. After detection of the start condition, a transition count is incremented for each transition detected as shown in step 293. It will be appreciated that a separate transition count may be maintained for each individual read mechanism or that detections made by multiple read mechanisms may be reflected in a single transition count. It will be further appreciated that that the threshold for non-logical transition detection may be different from the threshold for detection of logical transitions. The process of detecting transitions and incrementing a transition count continues until the detection of a stop condition as shown in step 295. As before, the stop condition may be, amongst other things, the detection of a logical transition. After the detection of the stop condition, the transition count is stored as shown in step 297 and the process ends as shown in step 299.

For the purposes of explanation, it may be useful to consider an exemplary execution of the method described in relation to FIG. 10. In this example, a column of three read mechanisms is provided for reading from a magnetic track. The transition count is set to increment during the time the column of read mechanisms passes over track between two adjacent logical transitions. The two outer read mechanisms are positioned near the edges of the magnetic track. As such, they encounter variations in magnetic field that might be significant variations, and that might not be detected by the read mechanism near the center of the track. Each time the variation in the magnetic field near a read mechanism is strong enough to be considered a transition, the transition count is incremented. Again, the threshold for the transition count may be different from the threshold used to determine the presence of a logical transition. In the present example, a separate transition count is maintained for each of the three read mechanisms. Once the column of read mechanisms reaches the ending of a logical transition, each of the transition counts is stored. For the purpose of the present example, it will be assumed that the transition count for the first read mechanism is <5>, the transition for the second read mechanism is <0>, and the transition count for the third read mechanism is <2>. Considered as a set, the aggregated transition count may be represented as <5, 0, 2>. As with other characterizations of non-uniformity described above, the stored transition counts may be used to differentiate between magnetic tracks having similar data. Take again the example of a thief wishing to duplicate a magnetic track to commit fraud. In one embodiment, the present invention provides for generating one or more transition counts to characterize a particular region of a track. The transition counts act as an authentication code or fingerprint. Even if the thief succeeds in copying the binary info from an original track to a duplicate, it will be nearly impossible to recreate the transition pattern of a particular region of the first track on the corresponding region of the duplicate. As such, the second track can be identified as an illegitimate copy and its use denied. Transition counts may also be used in evaluation of write mechanisms, generation of random numbers, generation of seeds for random numbers, formation of authentication keys, and other security measures.

In an alternative embodiment of the present method, rather than maintain a transition count, it is possible to maintain other signature values at the track edges. For example, the field strength might (actual or absolute) might be integrated or otherwise accumulated to determine a unique signature for the medium. The method might be implemented to maintain a cumulative variance in magnetic field properties over a certain region. The summation could be sampled at various times or in response to various conditions to similarly characterize regions of the magnetic track. A variation in signal strength over time along the edge or edges can be measured or maintained as well. Where two edges of the same track (or multiple edges of parallel tracks) are measured at the same time, such variation can be measured relative to other points on the medium, and thus independently of swipe speed. As these examples illustrate, various techniques can be used to measure or quantify the variations in the field at or near the edges of the track(s). It will be appreciated that the same techniques may be applied to regions of the track not proximate to the edges as well. Advantageously, these methods might be implemented to provide for another way to enhance the security using non-uniformity in magnetic tracks.

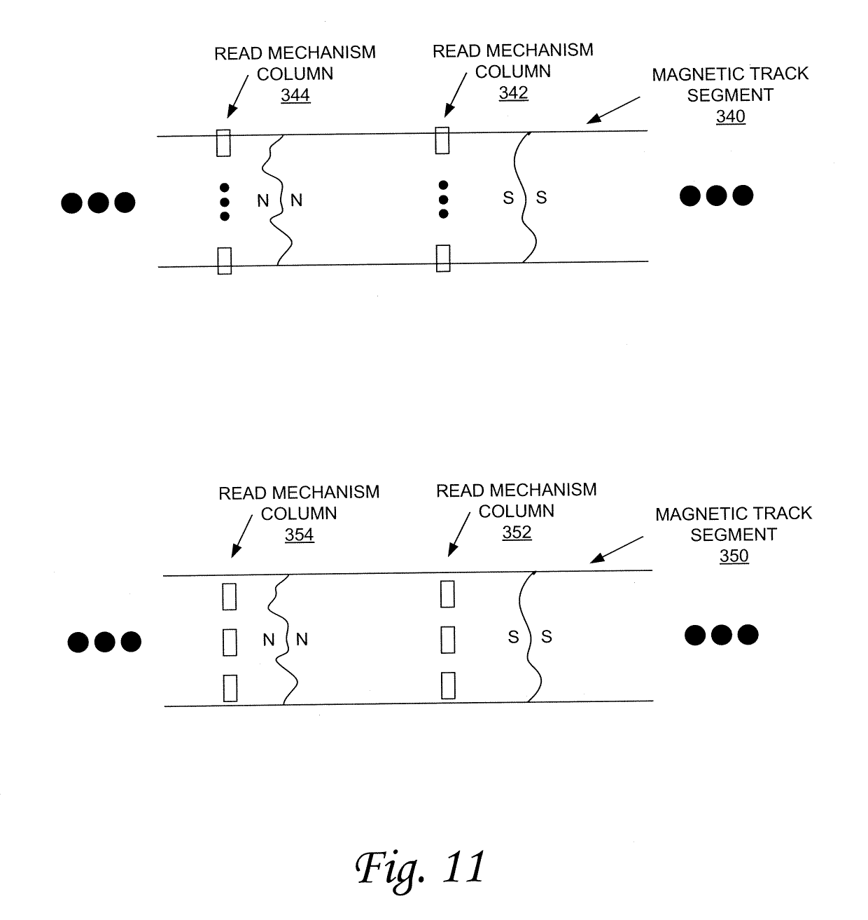

Various embodiments of the present invention have been described in relation to a plurality of read mechanisms for a single track where the read mechanisms are arranged as a single column, or a 1×N array. Other embodiments of the present invention may be described in relation to a plurality of read mechanisms for a given track where the read mechanisms are arranged as two or more columns or an M×N array. For example, FIG. 11 describes an exemplary configuration of an M×N array read mechanisms in accordance with one embodiment of the present invention. An example magnetic track segment 340 is illustrated. As before, a column of read mechanisms 342 is provided to read data from and to characterize the non-uniformity of track 340. However, in accordance with one embodiment of the present invention, a second column of read mechanisms 344 is provided as well. As noted, this could be extended in either direction to provide an M×N array. Additionally the array can be oriented such that the columns are perpendicular and the rows parallel to the track, or other orientations of the array can be provided.

To ease in the description, a specific example is depicted and described wherein two columns of magnetic read mechanisms 352 and 354 are provided to read from magnetic track 350. Each column in this example comprises three read mechanisms. Thus, this is an example of a 2×3 array. As will be described below, the presence of one or more additional column of read mechanisms might be used to measure non-uniformity of magnetic track 340 in additional ways. These additional characterizations of non-uniformity might be used, for example, to augment security in ways similar to those discussed previously.

U.S. Pat. No. 5,770,846 issued to Mos et al., and incorporated herein by reference in its entirety, describes a method of determining the distance between transitions on a magnetic track. Because distance between theoretically regular transitions can display random-like non-uniformity, the measurements of this non-uniformity can be used to enhance security in ways similar to those described above. For example, this determination of distance can be used to characterize the information pattern precisely in order to authenticate the information and the medium on which the information is stored. The Mos invention uses a leading and trailing read apparatus to determine the distance between transitions. However, in accordance with one embodiment, the present invention can be used in combination with methodologies such as those taught by Mos to improve the accuracy and precision of the determination of distance between transitions on a magnetic track. By using a leading column of read mechanisms instead of a single leading read mechanism and by using a trailing column of read mechanisms instead of a single trailing mechanism, the accuracy of distance determinations might be significantly increased. For example, whereas the prior invention could provide a single calculation describing the distance between transitions (for example, in terms of jitter value), the present invention can provide calculations of distance between sections of adjacent transitions. This could prove useful when the distance between edge sections of adjacent transitions are different than the distance between sections closer to the middle of the track. In another example, in accordance with the present invention distance measurements can be taken with respect to a read mechanism in the leading column and one or more of the read mechanisms in the trailing column. This could help accurately determine the exact shape of the transitions. Additionally, the signature methods taught by the Mos invention might be combined with the data set measurements of the head array as multiple checks of the same data. Advantageously, these multi-dimensional and more accurate distance measurements can be used as can other characterizations of non-uniformity to enhance security in ways similar to those described above. For example, multi-dimensional distance measurements could be used as the basis for an authentication signature for the medium. The exact distance patterns would be exceedingly difficult to intentionally reproduce. The uniqueness of the signature would provide significant security for the medium.

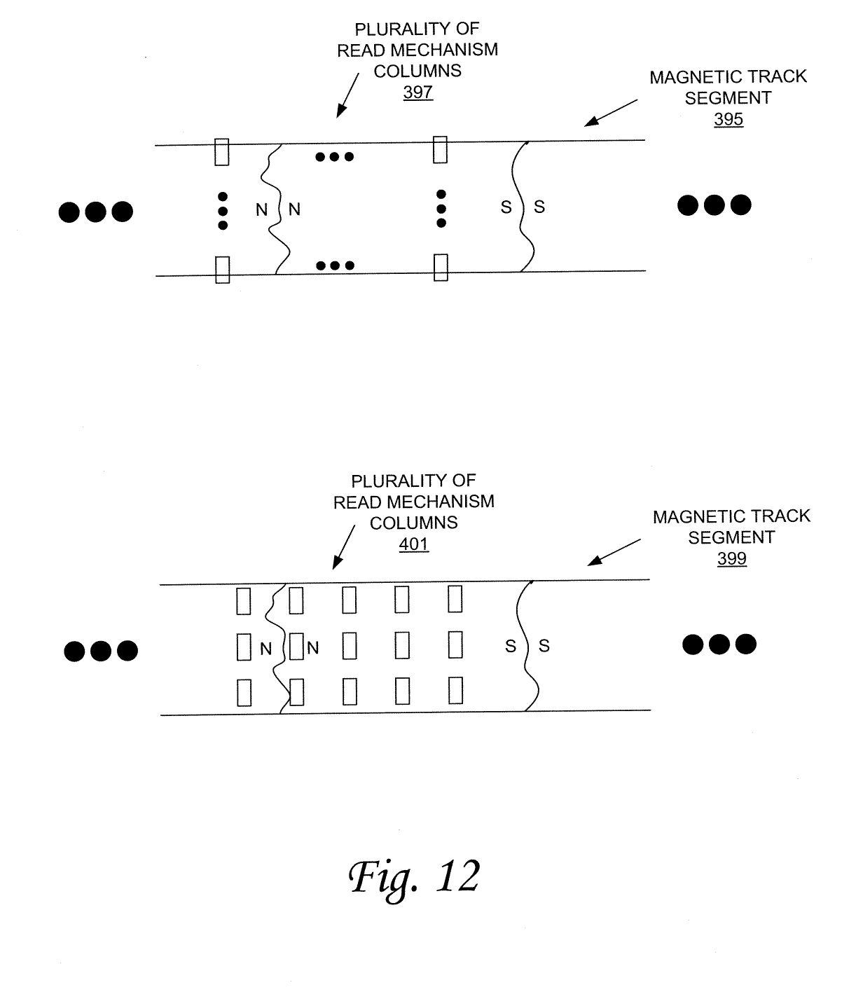

While the previous embodiment of the invention was described in relation to having two columns of read mechanisms, other advantages could be achieved by using larger numbers of read mechanisms in various array configurations. Increasing the number of read heads in a given area might be used to increase the resolution with which transitions and edge regions can be characterized. For example, FIG. 12 illustrates a magnetic track segment 395. A plurality of M columns of N read mechanisms 397 are provided for reading data from and characterizing non-uniformities of track 395. Depending on manufacturing techniques and technologies utilized, a concentrated array of read mechanisms might be implemented.

To further illustrate, in an example embodiment, five columns of three read mechanisms 401 are provided for track 399. The use of a plurality of columns allows for an alternative calculation of distance between sections of logical transitions. For example, if a leading read mechanism detects a particular section of a transition, it can be determined which trailing read mechanism was the last to detect the corresponding section of the previous transition. Alternatively, it can be determined which trailing read mechanism is the next to detect the corresponding section of the previous transition. Either way, if the distance between the corresponding read mechanisms is known, the distance between transitions can be closely estimated. This estimation might be performed independent of the speed at which the read mechanisms and the track pass each other. Again, these accurate estimates of distance can be used to generate authentication signatures or other random-like outputs to enhance security.

In another application of the present embodiment of the invention, the plurality of columns can be used to generate another type of detailed description of the non-uniformity of the magnetic track for the purposes of augmenting security. In one embodiment, a sensor is associated with each of a plurality of the read mechanisms. Again, it will be appreciated that different types of read mechanisms may be used. However, for the purposes of this example, it will be assumed that the read mechanisms are magneto-resistive effect readers. Responsive to certain triggering events, the sensors associate a numerical value with the current resistance values detected by the read mechanisms. The triggering event may be, amongst other things, the passing of a specified amount of time. Alternatively, it may be the detection of a certain pattern of logical transitions. Whatever the triggering event, the detected values can be stored. The stored values can be thought of as a two dimensional snapshot of a region of the magnetic track. A series of snapshots might be considered a moving picture of the transition as it passes by the array (much like a video is a moving picture of successive still images). Snapshots of corresponding regions of magnetic tracks can be used to verify the authenticity of the track in ways similar to those described above. Alternatively, image-processing algorithms could be used to compare snapshots to determine authenticity. Sufficiently rapidly taken snapshots could be used to form an accurate representation of the entire magnetic track. As before, this detailed characterization of the magnetic track can be used to differentiate it from another track having identical digital information. As the density of the array increases, resolution of each snapshot can increase, improving the accuracy or precision of the snapshot. Advantageously, the described embodiments of the present invention might be implemented to provide for a means of securing and authenticating media using magnetic tracks.

In another embodiment of the present invention, one or more columns of read mechanisms can be configured to detect remanent noise. Remanent noise may be understood as variations in magnetic field that are detected when reading a strip that has been uniformly saturated. This variance might be, for example, an artifact of production and the physical properties of the particular magnetic strip. For example, the spacing of magnetic particles can result in variations in the magnetic field even when the particles are similarly aligned. Because remanent noise varies greatly between magnetic tracks and its measurement is repeatable, a representation of remanent noise can be used to differentiate between magnetic tracks having identical data. The use of remanent noise as a means of differentiation is known in the art. See, for example, U.S. Pat. No. 5,365,586 to Indeck et al. However, one embodiment of the present invention allows for greater precision in detecting remanent noise. For example, a plurality of read mechanisms arranged as a column could be used to measure remanent noise. One or more read mechanisms could be used to measure remanent noise near the edges of the track while additional read mechanisms could be used to measure remanent noise near the middle. Advantageously, the invention can be implemented to augment the resolution of the fingerprint and enable greater accuracy in differentiation. In another embodiment, a plurality of read mechanisms could be arranged as a plurality of columns and used to measure remanent noise. In addition to providing greater resolution in measuring remanent noise, this configuration might be implemented to allow more precise location of regions in which remanant noise is measured. For example, the multidimensional array might be implemented to allow measurement regions to be defined between transitions or at a given distance away from transitions. An array of read mechanisms and processing functionality can be used to determine one or more desired locations at which to measure remanent noise. The above-described measurements of remanent noise may be used to generate authentication signatures and other values useful in security applications. For example, a representation of remanent noise measured from a region of a magnetic track may be stored on a portion of that track. When the card is later read from, the stored representation of remanent noise can be compared to a measurement of remanent noise taken during the later read process. If the stored representation and the later measurement match, the track can be verified as original. However, if a duplicate track bearing the same data is analyzed, a difference between the stored representation of remanent noise and the later measurement will be apparent and the duplicate track can be rejected. It will be appreciated that representations of remanent noise may themselves be processed to enhance security through encryption or other known methods. It will be further appreciated that individual read mechanisms in an array may be used both to measure remanent noise and detect transitions. In such a case, the sensitivity or thresholds of circuitry associated with read mechanisms may be adjusted between periods when the mechanisms are measuring remanent noise and detecting transitions. Additional adjustments to sensitivity and thresholds may be made responsive to the position of read mechanisms in the array. In another embodiment, certain read mechanisms in an array may be used only for detecting transitions while others are used only for detection of remanent noise.

Various embodiments disclosed herein include systems and methods for characterizing the token medium and comparing the characterization (also referred to as a fingerprint or signature) to subsequent characterizations from presented tokens. Comparison of a subsequent measurement to prior measurements can be used to authenticate the token being presented. In one embodiment, a characterization module can be provided to perform the characterization and store the characterization data. Such a module can be implemented using hardware, software or a combination thereof.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” traditional “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of reading data from a track of a magnetic stripe, comprising the steps of:
detecting a magnetic transition on the track by each of a plurality of read mechanisms arranged in a column across the track;
determining an epoch for each detection of the transition by the plurality of read mechanisms; and
characterizing the magnetic stripe based on the epochs determined for the transition detections.

2. The method of claim 1, further comprising, reading a second magnetic stripe, characterizing the second magnetic stripe based on epochs determined for transition detections in the second magnetic stripe and comparing a characterized data set for the first and second magnetic stripes to determine whether they are the same magnetic stripe.

3. The method of claim 1, wherein the epoch for a read mechanism comprises a measurement of elapsed time from a start time until the transition is detected by that read mechanism.

4. The method of claim 1, wherein the epoch for a read mechanism comprises a measurement of elapsed time between a time at which the transition is detected by that read mechanism, and a time at which the epoch is detected by another read mechanism.

5. The method of claim 1, wherein the epochs comprise a relative order in which the transition is detected by the plurality of read mechanisms.

6. The method of claim 1, wherein the step of characterizing comprises determining an order in which the transition is detected by the plurality of read mechanisms.

7. The method of claim 1, wherein the step of characterizing comprises determining the elapsed times until the detection of the transition at each of the plurality of read mechanisms.

8. The method of claim 1, wherein a characterization data set is stored to enable comparison with a data set from a subsequent characterization of a magnetic stripe.

9. The method of claim 1, wherein the column of read mechanisms is oriented in an array that is substantially perpendicular to the track.

10. The method of claim 1, further comprising the step of processing the epoch measurements to account for the speed at which the track passes by the read mechanisms.

11. The method of claim 1, wherein the step of characterizing comprises the step of using the epoch measurements to generate an authentication signature.

12. The method of claim 1, further comprising the step of using the epoch measurements to generate a random number or to generate a seed for a random number generator.

13. The method of claim 1, further comprising the step of determining the order in which two or more read mechanisms in the column detect a transition, and using the order determination in generating an authentication signature, in generating a random number or in generating a seed for a random number generator.

14. The method of claim 1, further comprising the step of counting the number of transitions detected by one or more read mechanisms in the column in a region of the magnetic track.

15. The method of claim 1, further comprising the step of counting the number of transitions detected by one or more read mechanisms in the column in a region of the magnetic track and using the transition count to generate an authentication signature.

16. The method of claim 1, further comprising the step of counting the number of transitions detected by one or more read mechanisms in the column in a region of the magnetic track and using the transition count to generate a random number, or a seed for a random number generator.

17. A device for reading data from a magnetic track, the device comprising:
a plurality of read mechanisms arranged so as to be oriented in a columnar array across the track when the track is moved relative to the array; and
detection circuitry coupled to the read mechanisms.

18. The device of claim 17, further comprising a characterization module coupled to the detection circuitry.

19. The device of claim 18, further comprising a characterization module coupled to the detection circuitry, wherein the characterization module is configured to
determine an epoch for each detection of the transition by the plurality of read mechanisms; and
characterize the magnetic stripe based on the epochs determined for the transition detections.

20. The device of claim 18, wherein the characterization module comprises software, hardware or a combination thereof.

21. The device of claim 19, wherein the characterization module is configured to characterize the magnetic stripe based on the epochs determined for the transition detections.

22. The device of claim 19, wherein the characterization module comprises a timer.

23. The device of claim 19, wherein the characterization module is configured to measure the elapsed time between detections of a transition by read mechanisms in the column.

24. The device of claim 23, wherein the time measurement is processed to account for the speed at which the track passes by the column of read mechanisms.

25. The device of claim 23, wherein the time measurement is used in generating an authentication signature.

26. The device of claim 23, wherein the time measurement is used in generating a random number or as a seed for a random number generator.

27. The device of claim 19, wherein the epoch for a read mechanism comprises a measurement of elapsed time from a start time until the transition is detected by that read mechanism.

28. The device of claim 19, wherein the epoch for a read mechanism comprises a measurement of elapsed time between a time at which the transition is detected by that read mechanism, and a time at which the epoch is detected by another read mechanism.

29. The device of claim 19, wherein the epochs comprise a relative order in which the transition is detected by the plurality of read mechanisms.

30. The device of claim 18, wherein the characterization module is configured to
determine remanent noise; and
characterize the magnetic strip based on the determination of remanent noise.
